(19) United States
(12) Patent Application Publication
(10) Pub. No.: US 2002/0051018 A1
(43) Pub. Date: May 2, 2002

(54) Apparatus and method for browser interface operation

(76) Inventor: Nan-Ting Yeh, Taipei (TW)

Correspondence Address: Michael D. Bednarek, SHAWPITTMAN, 1650 Tysons Boulevard, McLean, VA, 22102-4859, US

(21) Appl. No.: 09/863,350

(22) Filed: May 24, 2001

(30) Foreign Application Priority Data
Oct. 26, 2000 (TW) 089122627

(51) Int. Cl. G06F 3/00; G06F 13/00

(52) U.S. Cl. 345/784; 345/769

(57) ABSTRACT

The invention provides an apparatus and method to scroll browsing display of web pages in a browser by dragging web pages with an input device. The apparatus for browser interface operation comprises: a web page scroll event detector and a web page link event detector. When the dragging distance is longer than a predetermined length, the apparatus sends a web page scroll request to the browser for scrolling the web page. When the browser receives the web page scroll request and it analyzes a vertical and horizontal component distance of the dragging distance. The browser then scrolls the horizontal scroll bar based on the horizontal component distance and the vertical scroll bar based on the vertical component distance. When the dragging distance is not longer than a predetermined length, the apparatus sends a web page link request to the browser for executing embedded web page link.

### REFERENCE TO RELATED APPLICATIONS

The present application claims priority to Taiwan application No. 089122627 entitled “Apparatus and method for browser interface operation” filed on Oct. 26, 2000.

### BACKGROUND OF THE INVENTION

1. Field of the Invention

The invention is generally related to computers and computers software therewith, and more particularly, to browsing interface scroll via a web page scroll event detector and a web page link event detector.

2. Description of the Related Art

As the Internet prevails, information is made available on the Internet. The information agents transferred from GOPHER, FTP that offers information in forms of texts and files to WWW (World Wide Web) that requires a browser to display multimedia format information retrieved from the Internet. Information is usually presented in a web page on the WWW. Each web page displayed in a browser contains images, texts, video, sounds, animation and embedded hyperlinks in the forms of icons, images or texts. Users may read the information in the web pages or click on the embedded hyperlinks with input device such as a mouse to jump to other web pages at different location on the WWW. As a result, web pages may contain large content such that it has to be displayed in several portions on the screen. Scroll bars on the browser windows accordingly can be used to help users to scroll through all information on the web pages.

Most of the current browsers provide both vertical scroll bars and horizontal scroll bars for users to scroll browsing display of web pages in a browser by controlling vertical scroll bars and horizontal scroll bars via input device such as a mouse or up and down keys on the keyboard. Or users may simply use page down and page up keys on the keyboard to scroll the display of web pages in a page-by-page manner.

However, due to the fact that manipulation of scroll bar with either a mouse or up and down keys is not precise and does not always coordinates with the viewer's focus shift, browsing is often interrupted by readjusting vertical scroll bar and horizontal scroll bar in order to go to desired portions of web pages. In addition, since said means to scroll via page up and page down keys scroll the display of web pages in a page-by page manner, users can easily lose track and have to spend extra efforts relocating and distinguishing portions that users have or haven't read.

FIG. 1 is a prior art browser 100 that comprises a vertical scroll bar 101 and a horizontal scroll bar 102. Users utilizes input device such as a mouse or a screen keyboard to control vertical slider 103 of the vertical scroll bar 101 so as to scroll web page display 105 in either up or down direction. With the same means, horizontal slider 104 of the horizontal scroll bar 102 is utilized to scroll left and right web page display 105 in either left or right direction.

### SUMMARY OF THE INVENTION

The objective of the present invention is to provide an apparatus for browser interface operation. It provides an apparatus to scroll browsing display of web pages in a browser by dragging web pages with an input device. The apparatus for browser interface operation comprises: a web page scroll event detector and a web page link event detector. A web page scroll event detector is utilized to detect the distance dragged by a user on the web page with an input device such as a mouse.

When the dragging distance is longer than a predetermined length, the apparatus according to the present invention sends a request to the browser for scrolling the display of the web page. A web page link event detector is utilized to detect the distance a user dragged on the web page with an input device such as a mouse. When the dragging distance is not longer than a predetermined length, the apparatus according to the present invention sends a request to the browser for executing embedded web page link.

Correspondingly, as the browser receives a request for web page scroll from web page scroll event detector, the browser then follows the horizontal component distance of the dragging distance received from the input device to scroll said same horizontal distance of the browser display. Likewise, the browser follows the vertical component distance of the dragging distance directed by the input device to scroll said same vertical distance of the browser display. If browser receives a link request from the web page link event detector, browser then links to the web page corresponding to the link.

Said input device can be a mouse. If a user clicks on and drags the mouse, the action causes a cursor on the screen to move. Web page scroll event detector and web page link event detector sense the movement of the cursor on the browser display. Concurrently, a decision is made whether the dragging distance is longer than a predetermined length according to the system set up.

If yes, the web page scroll event detector determines that the user is issuing a web page scroll event and issue a web page scroll request to the browser. The browser receives the web page scroll request and analyzes a vertical and horizontal component distance of the dragging distance sensed by the mouse. The browser then scrolls both the horizontal scroll bar based on the horizontal component distance and the vertical scroll bar based on the vertical component distance.

On the other hand, if the dragging distance is not longer than a predetermined length according to the system set up, the web page link event detector determines that the user is issuing a web page link event. The browser receives the web page link event, initializes the link embedded in the web page and links to the web page corresponding to the link. Provided that the user issues a web page link event at the portion of the web page, which is not embedded with hyperlinks, the web page link event then considered invalid for the browser. As a result, the browser does not respond to the web page link event issued.

When a user clicks a hypertext link, the user may slightly click on and drag the mouse by accident. The apparatus for browser interface operation according to the invention may fail to distinguish the user's action between clicking on a link from scrolling the display of web pages. Accordingly, a predetermined length according to the system set up ranges up to 5 or 7 pixels on the display screen is determined to avoid the confusion resulted from manually operating a mouse.

Said input device can also be a touch screen which is usually coupled to a hand held PC or a Personal Digital Assistant. Manually operating touch screen has the same problem as manually operating a mouse. A user may only desire to click on the link embedded in the web page. However, due to user's imprecise operation of a mouse, the user may accidentally click on and drag the display of the web page with the intention to click only. Therefore, web page scroll event detector and web page link event detector then sense the movement of the cursor on the browser display. Concurrently, a decision is made whether the dragging distance is longer than a predetermined length according to the system set up.

If yes, the web page scroll event detector determines that the user is issuing a web page scroll event and sends a web page scroll request to the browser. The browser receives the web page scroll request and analyzes a vertical and horizontal component distance of the dragging distance sensed by the mouse. The browser then scrolls both the horizontal scroll bar based on the horizontal component distance and the vertical scroll bar based on the vertical component distance.

On the other hand, if the dragging distance is not longer than a predetermined length according to the system set up, the web page link event detector determines that the user is issuing a web page link event. The browser receives the web page link event, initializes the link embedded in the web page and links to the web page corresponding to the link. Provided that the user issues a web page link event at the portion of the web page, which is not embedded with hyperlinks, the web page link event then considered invalid for the browser. As a result, the browser does not respond to the web page link event issued.

The other objective of the present invention is to provide a method for browser interface operation based on the apparatus according to the present invention. It provides a method to scroll browsing display of web pages in a browser by dragging web pages. The method for browser interface operation comprises clicking on and dragging on the web page via the input device, for example, a mouse or a touch screen. Thereafter, determining the dragging distance by comparing the dragging distance with a predetermined length.

If the dragging distance is-longer than-the predetermined length, the browser analyzes a vertical and horizontal component distance of the dragging distance sensed by the input device. The browser then scrolls both the horizontal scroll bar based on the horizontal component distance and the vertical scroll bar based on the vertical component distance.

On the other hand, the dragging distance is not longer than the predetermined length; the browser initializes the link embedded in the web page and links to the web page corresponding to the link. Provided that the user issues a web page link event at the portion of the web page, which is not embedded with hyperlinks, the web page link event then considered invalid for the browser. As a result, the browser does not respond to the web page link event issued.

### BRIEF DESCRIPTION OF DRAWINGS

The following detailed description, given by way of an example and not intended to limit the invention to the embodiments described herein, will best be understood in conjunction with the accompanying drawings, in which:

FIG. 1 is a perspective view illustrating prior art browser 100;

FIG. 2 is a perspective view illustrating the browser 200 in accordance with the present invention;

FIG. 3 is a perspective view illustrating the apparatus for browser interface operation in accordance with the present invention;

FIG. 4 is a perspective view of mechanism for operating the apparatus described in the FIG. 3;

FIG. 5 is a flowchart illustrating scroll determination steps for a web page scroll event detector; and

FIG. 6 is a flowchart illustrating scroll determination steps for a web page link event detector.

### DETAILED DESCRIPTION OF THE INVENTION

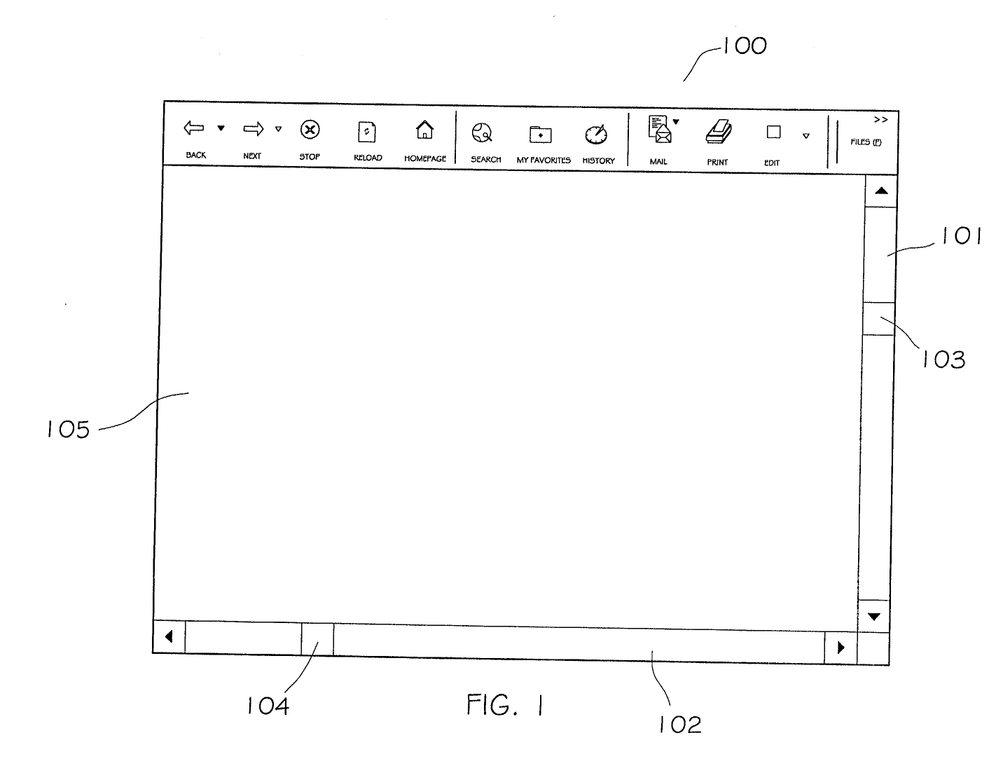

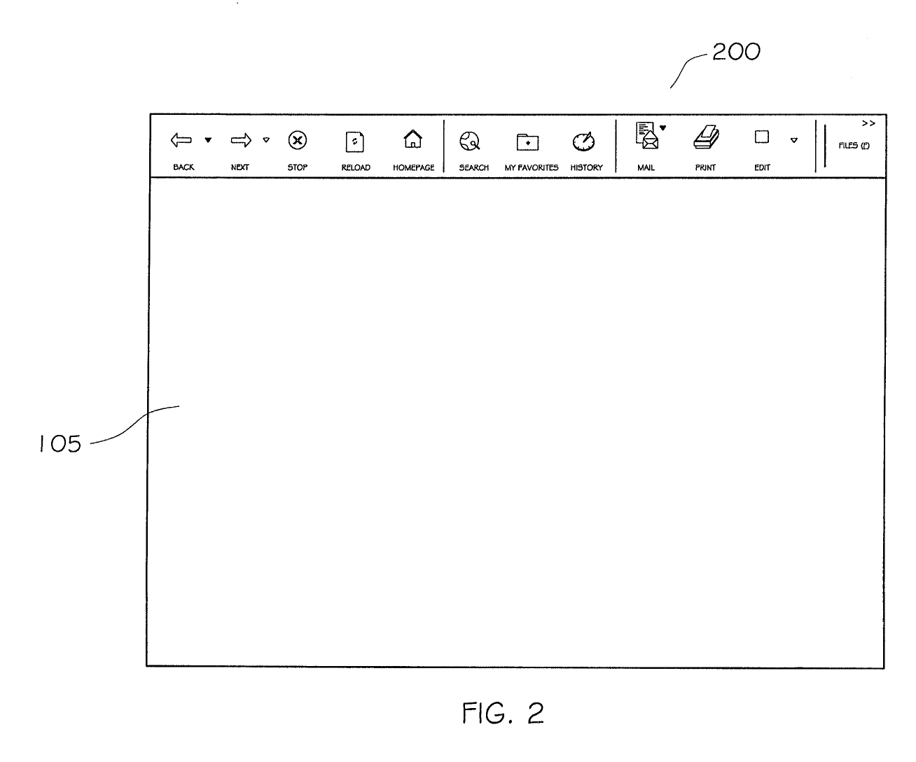

FIG. 2 illustrates a browser 200 in accordance with the present invention. Due to the fact that both the vertical and horizontal scroll bars are incorporated into the browser, the browser 200 in FIG. 2 has a larger display area than browser 100 in FIG. 1. According to a preferred embodiment shown in FIG. 2, a user scroll browsing display of web pages in a browser by clicking on and dragging via mouse or a touch screen. In addition, the scrolling is not limited to only vertical scrolling or only horizontal scrolling.

At present, there are a few graphics software available also utilized means of dragging web page for scrolling as browsing graphics. However, in an embodiment therein browser 100 adopts said means utilized by graphics software, confusions may occur for the browser when a user desire to scroll the display of a web page with said means but accidentally clicks on and drag at the portion with embedded links or when a user clicks on the portion of the web page, but accidentally scroll the display of the web page due to the imprecise action. As a result of above factors, the scrolling of a typical browser 100 remains restricted to be completed with by manipulating a vertical scroll bar and horizontal scroll bar.

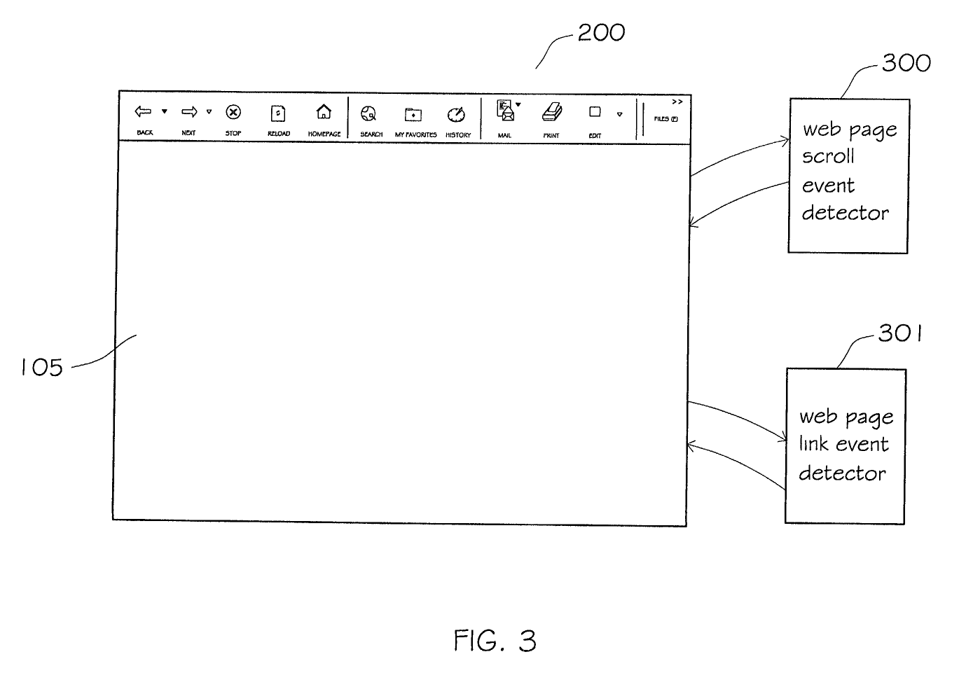

As shown in FIG. 3, browser 200 is an embodiment of an apparatus for browser interface operation in accordance with the invention provided to address said potential confusion. Browser can distinguish web scroll event from web link event.

In FIG. 3, browser 200 further comprises a web page scroll event detector 300 and a web page link event detector 301. A web page scroll event detector 300 is used for detecting whether a dragging action occurred on the web page display 105 of browser 200 and whether the dragging distance is longer than a predetermined length.

If a dragging action occurred on the web page display 105 of browser 200 and the dragging distance is longer than a predetermined length, the web page scroll event detector 300 then issue a web page scroll request to the browser 200 to scroll the web page display 105 of the web page. The scroll request is based on the vertical and horizontal component distance analyzed from the dragging distance sensed on the web page. After the browser 200 receives the scroll request, the browser scroll the hidden horizontal scroll bar according to the horizontal component distance and the hidden vertical scroll bar according to the vertical component distance.

If a user accidentally drags a mouse while clicks on the mouse, the dragging distance resulted from the slight dragging action is usually shorter than the predetermined length. When the dragging distance is not longer than a predetermined length according to the system set up, the web page link event detector 301 determines that the user is issuing a web page link event and informs the browser 200. The browser 200 receives the web page link event, initializes the link embedded in the web page and links to the web page corresponding to the link. Provided that the user issues a web page link event at the portion of the web page, which is not embedded with hyperlinks, the web page link event then considered invalid for the browser 200. As a result, the browser 200 does not respond to the web page link event issued.

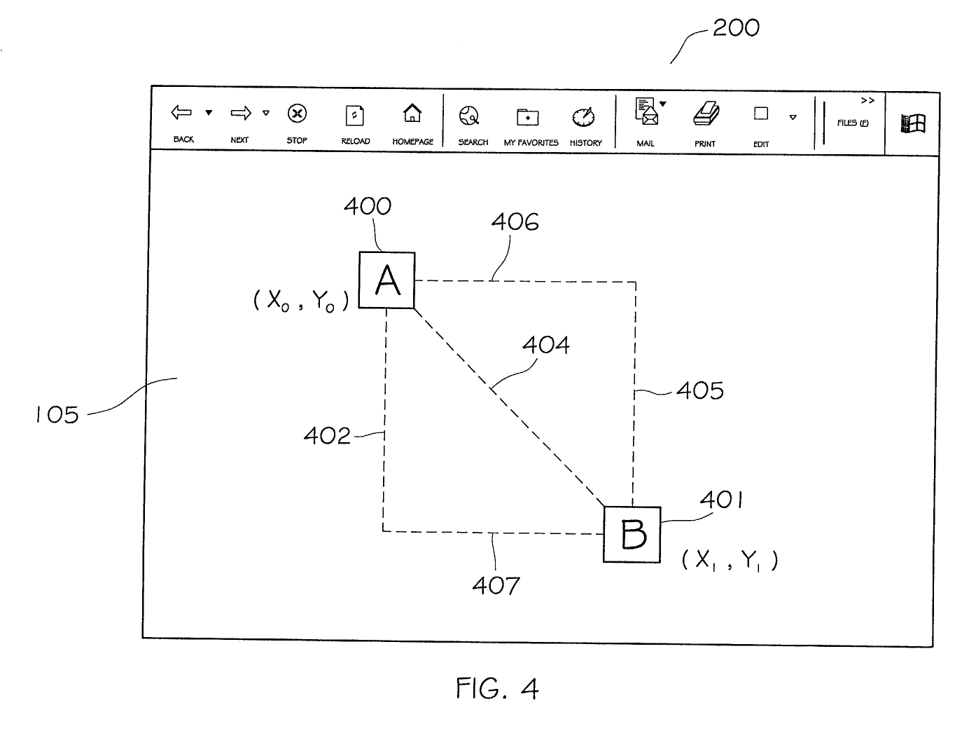

FIG. 4 illustrates a detailed operation of the embodiment shown in FIG. 3. The user clicks on the mouse at point A 400 with coordinates set as (X₀, Y₀) and followed to drag the mouse to the point B 401 with coordinates set as (X₁, Y₁). The distance from point A to point B defines the dragging distance 404. If the dragging distance 404 is longer than the predetermined length, which set as a range up to 5 or 7 pixels, the web page scroll event detector 300 (as shown in FIG. 3) determines that the user is issuing a web page scroll request and sends a web page scroll request to the browser 200. The browser 200 receives the web page scroll request and analyzes a vertical component distance 402 and horizontal component distance 406 of the dragging distance 404. The browser then scrolls the web page display 105 by adjusting both the horizontal scroll bar based on the horizontal component distance 406 and the vertical scroll bar based on the vertical component distance 402.

On the other hand, if the dragging distance is not longer than a predetermined length according to the system set up, a range up to 5 or 7 pixels, web page link event detector 301 determines that the user is issuing a web page link event and informs the browser 200. The browser 200 checks whether there is any link embedded at point A. If yes, browser 200 initializes the link embedded at point A.

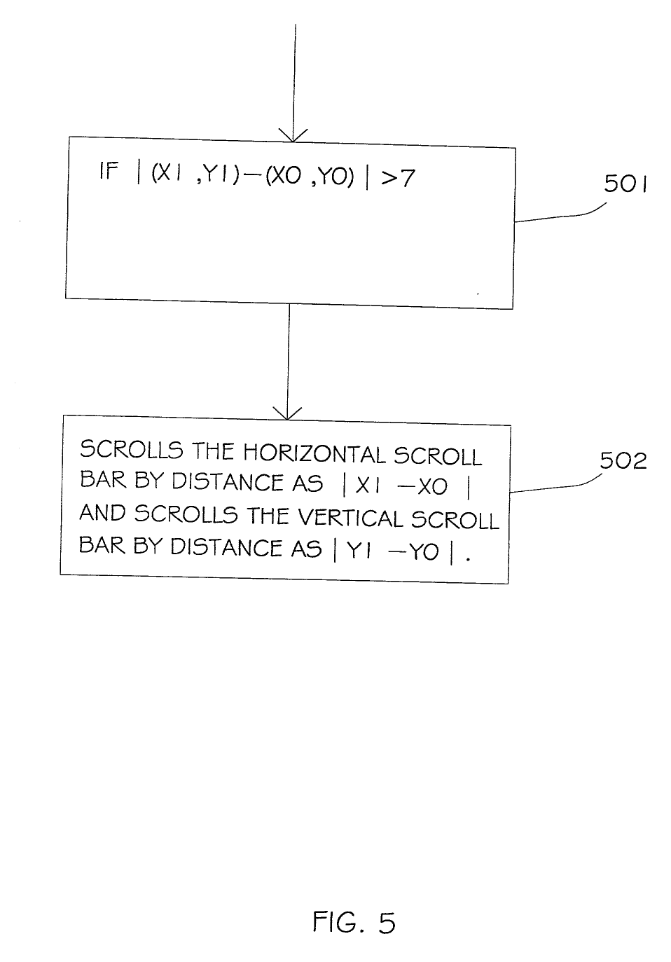

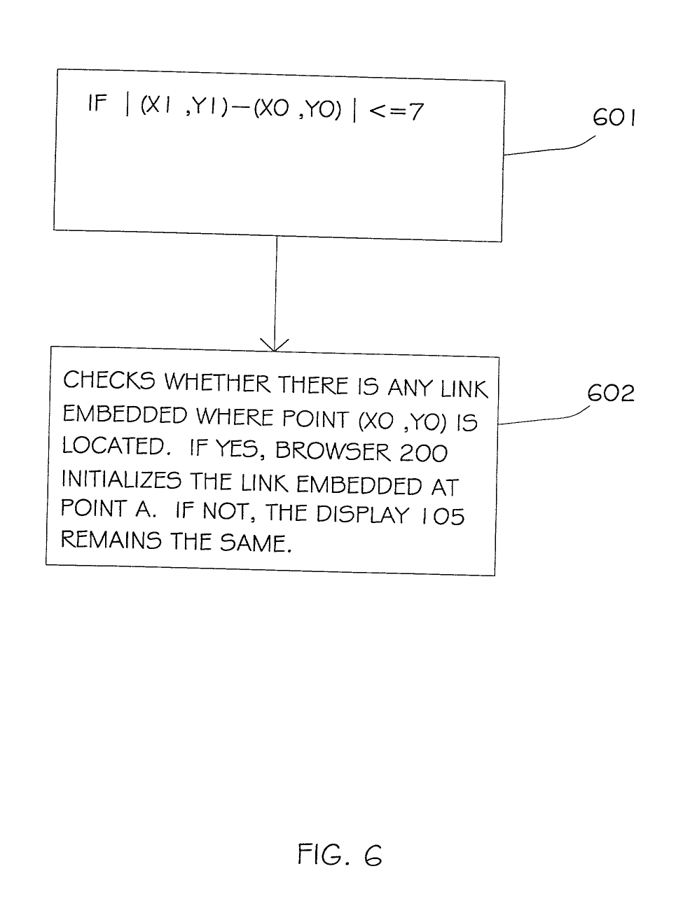

FIG. 5 and FIG. 6 illustrates a flowchart of operation steps depicted in FIG. 4. FIG. 5 illustrates an operation step 501 where web page scroll event detector 300 determines if the user issues a web page scroll event in web page display 105 of browser 200 and sends a web page scroll request to the browser 200. At step 501, if the distance satisfies |(X₁, Y₁)−(X₀, Y₀)|>7, the control moves to step 502. At step 502, the browser 200 scrolls the horizontal scroll bar by distance as |X₁−X₀|. If the value resulted from X₁−X₀ is positive, the scrolling is toward the right on the horizontal bar. On the other hand, if the value resulted from X₁−X₀ is negative, the scrolling is toward the left on the horizontal bar. Likewise, on the vertical scroll bar, the corresponding scrolling distance is |Y₁−Y₀|. If the value resulted from Y₁−Y₀, the scrolling is downward on the vertical scroll bar. On the other hand, if the value resulted from Y₁−Y₀ is negative, the scrolling is upward. FIG. 6 illustrates an operation step 601, where web page link event detector 301 determines if the user issues a web page link event in web page display 105 of browser 200. At step 601, if the distance satisfies |(X₁, Y₁)−(X₀, Y₀)|<=7, the control moves to step 602. At 602, the browser 200 checks whether there is any link embedded where point A (X₀, Y₀) is located. If yes, browser 200 initializes the link embedded at point A. If not, the display 105 remains the same.

While the invention has been described with reference to various illustrative embodiments, the description herein should not be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. An apparatus for browser interface operation, wherein the browser scroll browsing display of web pages in a browser by dragging web pages with an input device, said apparatus for browser interface operation comprising:
a web page scroll event detector for detecting if a dragging distance from clicking on and dragging action of an input device on the web page display in the browser is longer than a predetermined length, if yes, the web page scroll event detector sending a web page scroll request to the browser; and
a web page link event detector for detecting if a dragging distance from clicking on and dragging action of an input device on the web page display in the browser is not longer than a predetermined length, if yes, the web page link event detector send a web page link request to the browser;
wherein as the browser receives the web page scroll request, the browser then scrolls the horizontal scroll bar of the browser based on the horizontal component distance of the dragging distance and the vertical scroll bar of the browser based on the vertical component distance of the dragging distance, and as the browser receives the web page link request, the browser sends a web page link request to the browser for executing embedded web page link.

2. An apparatus according to claim 1, wherein said input device is mouse.

3. An apparatus according to claim 1, wherein said input device is a touch screen.

4. An apparatus according to claim 1, wherein the horizontal component distance is used as a basis for the browser to execute web page scroll request on the horizontal bar.

5. An apparatus according to claim 1, wherein the vertical component distance is used as a basis for the browser to execute web page scroll request on the vertical bar.

6. A method for browser interface operation, the browser scroll browsing display of web pages in a browser by dragging web pages with an input device, said method for browser interface operation comprising:
clicking on and dragging via an input device for a distance on the web page display in the browser;
determining whether the dragging distance is longer than a predetermined length, if yes, the browser scrolling the web page, wherein the browser scrolls the horizontal scroll bar of the browser based on the horizontal component distance of the dragging distance and the vertical scroll bar of the browser based on the vertical component distance of the dragging distance.

7. The method according to claim 6, wherein said input device is mouse.

8. The method according to claim 6, wherein said input device is touch screen.
